(19) United States
(12) Patent Application Publication
(10) Pub. No.: US 2026/0121766 A1
(43) Pub. Date: Apr. 30, 2026

(54) INTERCONNECT MODULE FOR HIGH-SPEED DATA TRANSMISSION

(71) Applicant: Samtec, Inc., New Albany, IN (US)

(72) Inventors: Marc EPITAUX, Gland (CH); John L. NIGHTINGALE, Portola Valley, CA (US); John CORONATI, Colorado Springs, CO (US)

(21) Appl. No.: 19/116,770

(22) PCT Filed: Oct. 26, 2023
(86) PCT No.: PCT/US2023/077825

§ 371 Date: Mar. 28, 2025

Related U.S. Application Data
(60) Provisional application No. 63/381,032, filed on Oct. 26, 2022.

(51) Int. Cl. H04B 10/80; G02B 6/42; H04B 10/40

(52) U.S. Cl. CPC H04B 10/802; G02B 6/4214; G02B 6/4238; G02B 6/424; G02B 6/4298; H04B 10/40; H04B 10/807

(57) ABSTRACT

An interconnect module having a base substrate with a microcontroller on a top surface and a photonic integrated circuit (PIC) and photodetector array on an opposed bottom surface is described. The interconnect module has a top and bottom fiber assembly, which both have a row of optical fibers. The bottom fiber assembly is actively aligned with the PIC to maximize optical coupling efficiency between the bottom fiber assembly and the PIC and then permanently affixed in this position. The top fiber assembly is actively aligned with the photodetector array to maximize optical coupling efficiency between the top fiber assembly and the photodetector array and then permanently affixed in this position.

### CROSS-REFERENCE TO RELATED APPLICATIONS

This claims priority to U.S. Patent Application Ser. No. 63/381,032 filed Oct. 26, 2022, the disclosure of which is hereby incorporated by reference as if set forth in its entirety herein.

### BACKGROUND

Optical communication channels, using modulated light signals, may be used to rapidly and reliably transmit information in a variety of applications such as fiber optic communication networks or computer systems.

Optical fiber optic networks have advantages over other types of networks such as electrically conductive cable-based networks. Many existing electrically conductive cable networks operate at near maximum possible data transmission rates and at near maximum possible distances for copper wire cable technology. Fiber optic networks may be used to reliably transmit data at higher rates over further distances than is possible with copper cable networks.

Data communication systems employing high speed optical interconnects may provide improved performance when compared to other data communication systems. In one example, the performance of computer systems can be restricted by the rate that computer processors can access memory or communicate with other components in the computer system. The restriction can be due, in part, to the physical limitations of data interconnects such as electrical connections. For example, electrical pins with a particular size and/or surface area that may be used in electrical connections may only be capable of transmitting a specific amount of data, and in turn this may limit the maximum bandwidth for data signals. In some circumstances, such connections may result in bottlenecks when the maximum bandwidth of connections becomes a performance limiting factor. High speed optical interconnects using light signals may permit transmission of information at increased data rates to decrease or eliminate such bottlenecks.

Although modulated light signals may be used to transmit data at increased data rates in fiber optic networks, computer systems or other applications, almost all memory, switching, and processing components of such systems use electrical signals. Accordingly, optoelectronic assemblies may be used to convert electrical signals to optical signals, convert optical signals to electrical signals, or convert both electrical signals to optical signals and optical signals to electrical signals. A key component of an optoelectronic assembly is an optical engine, which provides optical-to-electrical and/or electrical-to-optical conversion in high-speed communication systems. Optical engines may include a microcontroller that controls operation of the optical engine. The optical engine may be part of an optoelectronic subassembly that in turn is part of an optoelectronic assembly or an optical interconnect module. The optoelectronic subassembly may incorporate an optical engine in a package having an electrical, mechanical and/or thermal interface that is easily integrated into a computer or communication system. The optoelectronic assembly may incorporate an optical engine or optoelectronic subassembly in a package having an optical interface easily integrated into a computer or communication system, such as for example, either detachable or permanently attached optical fibers in optical alignment with the optical engine. An optical interconnect module may also have desirable electrical, mechanical, thermal, and optical interface properties and may be considered equivalent to an optoelectronic assembly. Examples of optoelectronic assemblies and optical interconnect modules include packages compliant with multi-source agreement standards such as QSFP, QSFP-DD, OSFP, COBO, OIF-CPO module, and many others.

An optical engine or an optical engine integrated into any of these higher-level packages may be configured as a transmitter, a receiver, or a transceiver. In a transmitter, the optical engine converts electrical signals into optical signals. In a receiver, the optical engine converts optical signal into electrical signals. In a transceiver, the optical engine both converts electrical signals into optical signals and converts optical signals into electrical signals.

As the bandwidth and channel density of high-speed communication systems has increased, there is a need for improvements in optical engines to support higher data transfer rates, to decrease the optical engine size, and to provide an optical engine that is easily integrated with other data communication system components.

### SUMMARY

In one aspect of the present disclosure, an interconnect module has a base substrate having a first surface and a second surface opposite the first surface. At least a portion of the base substrate can be transparent. The interconnect module can include a photonic integrated circuit mounted on the base substrate. The photonic integrated circuit originates at least one transmit channel optical path. The interconnect module can include a photodetector array mounted on the base substrate. The photodetector array terminates at least one receive channel optical path. The interconnect module can further include an isolator assembly having an optical isolator and an optical block. The at least one transmit channel optical path can pass through the optical isolator, thereby reducing or eliminating feedback to the photonic integrated circuit. The at least one receive channel optical path passes through the optical spacer.

In another aspect of the present disclosure, an interconnect module has a top fiber assembly that includes a plurality of transmit optical fibers and a bottom fiber assembly that includes a plurality of receive optical fibers. The plurality of transmit optical fibers are offset in a lateral direction relative to the plurality of receive optical fibers.

In yet another aspect of the present disclosure, a method of assembling an interconnect module is described. The method includes the step of aligning a bottom fiber assembly on a top surface of an optical engine subassembly so that all transmit optical channels are aligned. The bottom fiber assembly is then permanently affixed in this alignment to the optical engine subassembly. The method proceeds by aligning a top fiber assembly on a top surface of the bottom fiber assembly so that all receive optical channels are aligned. The top fiber assembly is then permanently affixed in this alignment to the bottom fiber assembly.

In still another aspect of the present disclosure, an interconnect module can include a base substrate having a first surface and a second surface opposite the first surface. At least a portion of the base substrate can be transparent. The second surface of the base substrate can be configured to be mounted to a host substrate using C4 solder bumps having no copper pillars. The interconnect module can further include a photonic integrated circuit mounted on the second surface of the base substrate using C2 bumps having copper pillars.

In another aspect of the present disclosure, an interconnect module can include a base substrate having a first surface and a second surface opposite the first surface, wherein at least a portion of the base substrate is transparent. The interconnect module can further include a photonic integrated circuit mounted on the base substrate, wherein the photonic integrated circuit originates at least one transmit channel optical path. The interconnect module can further include a fiber assembly having a plurality of data transmission optical fibers. The interconnect module can further include at least one light delivery optical fiber configured to supply light or optical power to the photonic integrated circuit.

### BRIEF DESCRIPTION OF THE DRAWINGS

The foregoing summary, as well as the following detailed description of the present disclosure, will be better understood when read in conjunction with the appended drawings. For the purposes of examples of the present disclosure, there is shown in the drawings illustrative embodiments. It should be understood, however, that the present disclosure is not limited to the precise arrangements and instrumentalities shown. In the drawings:

FIG. 1 is a top perspective view of an interconnect module in one example;

FIG. 2 is an exploded top perspective view of the interconnect module shown in FIG. 1;

FIG. 3 is a bottom plan view of the interconnect module shown in FIG. 1;

FIG. 4 is a side elevation view of the interconnect module shown in FIG. 1;

FIG. 5 is a cross-sectional view of a portion of the interconnect module shown in FIG. 1 electrically connected to a host substrate;

FIG. 6 is a bottom plan view of an exemplary photonic integrated circuit (PIC) chip according to an embodiment of the current invention;

FIG. 7 is a perspective view of a lens array of the interconnect module shown in FIG. 1;

FIG. 8 is a perspective view of an isolator assembly of the interconnect module shown in FIG. 1;

FIG. 9 is a perspective view of a bottom fiber assembly of the interconnect module shown in FIG. 1;

FIG. 10 is a perspective view of a top fiber assembly of the interconnect module shown in FIG. 1;

FIG. 11A is a side elevation view of a portion of the interconnect module shown in FIG. 1, including a transmit (Tx) optical path and a receive (Rx) optical path in one example;

FIG. 11B is a schematic sectional view of a fiber terminating at a fiber ferrule in one example;

FIG. 11C is a schematic sectional view of a fiber terminating at a fiber ferrule in another example;

FIG. 12 is a perspective view of the top fiber assembly shown in FIG. 9 mounted to the bottom fiber assembly shown in FIG. 10; and

FIG. 13 shows a flowchart of an assembly method of the interconnect module shown in FIG. 1.

### DETAILED DESCRIPTION

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used herein, the singular forms “a,” “an,” and “the” apply with full force and effect to the plural “at least one” and a plurality unless otherwise indicated. Further, reference to a plurality as used herein apply with equal force and effect to the singular “a,” “an,” “one,” and “the,” and further includes “at least one” unless otherwise indicated. Further still, reference to a particular numerical value in the specification including the appended claims includes at least that particular value, unless otherwise indicated.

The term “plurality”, as used herein, means more than one. When a range of values is expressed, another example includes from the one particular value and/or to the other particular value. All ranges are inclusive and combinable.

The term “substantially,” “approximately,” “about,” and derivatives thereof, and words of similar import, when used to described sizes, shapes, spatial relationships, distances, directions, and other similar parameters includes the stated parameter in addition to a range up to 10% more and up to 10% less than the stated parameter, including up to 9% more and up to 9% less, including up to 8% more and up to 8% less, including up to 7% more and up to 7% less, including up to 6% more and up to 6% less, including up to 5% more and up to 5% less, including up to 4% more and up to 4% less, including up to 3% more and up to 3% less, including up to 2% more and up to 2% less, and including up to 1% more and up to 1% less, unless otherwise indicated.

It should be noted that the illustrations and discussions of the embodiments and examples shown in the figures are for exemplary purposes only and should not be construed as limiting the disclosure. One skilled in the art will appreciate that the present disclosure contemplates a range of possible modifications of the various aspects, embodiments and examples described herein. Additionally, it should be understood that the concepts described above with the above-described embodiments and examples may be employed alone or in combination with any of the other embodiments and examples described above. It should further be appreciated that the various alternatives described above with respect to one illustrated embodiment can apply to all other embodiments and examples described herein, unless otherwise indicated.

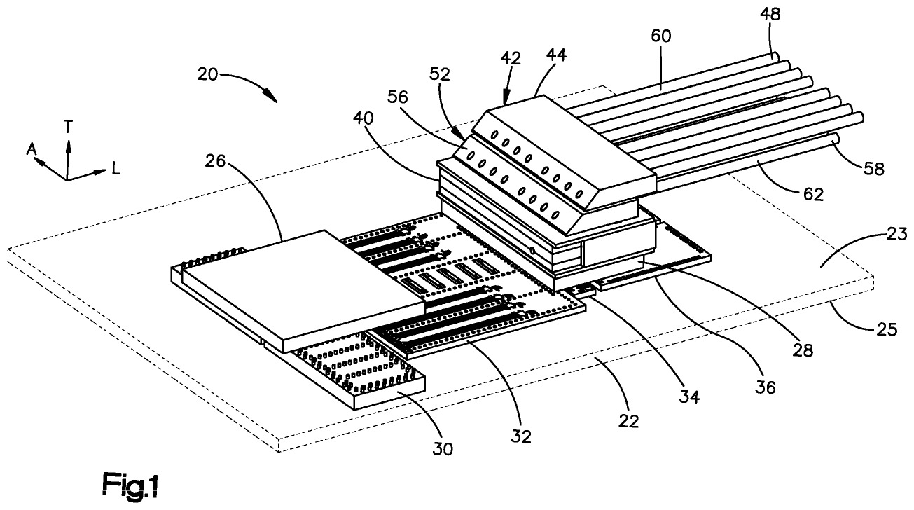

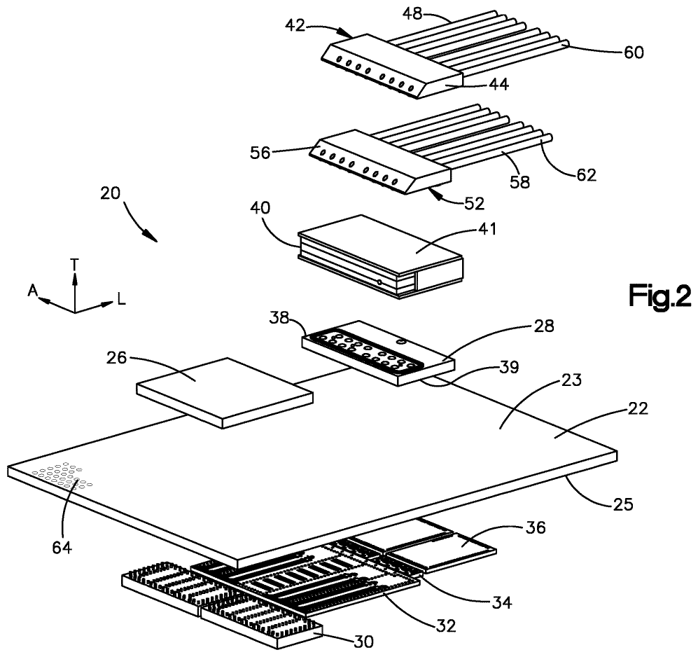

Referring to FIGS. 1-4, an interconnect module 20 can be configured as an optical transceiver, which includes an optical transmitter and an optical receiver. Alternatively, the interconnect module 20 can be configured as an optical transmitter. Alternatively still, the interconnect module 20 can be configured as an optical receiver. The interconnect module 20 can include a base substrate 22 and optical, electrical, and optoelectronic elements mounted to the base substrate 22, as is described in more detail below. In one example, at least a portion of the base substrate 22 can be transparent, and thus the base substrate 22 can be referred to as a transparent base substrate. The term transparent means that at least a portion of the transparent base substrate 22 is transparent at an operating wavelength of the interconnect module 20, not necessarily at wavelengths visible to the human eye. For example, the operating wavelength of the interconnect module 20 may be in a range of wavelengths between 1200 and 1600 nm. Thus, light within this wavelength range can readily propagate through the base substrate 22. In some examples, an entirety of the base substrate 22 can be transparent. In other examples, a portion of the base substrate 22 is transparent at a location where the light propagates through the base substrate 22 during operation. The base substrate 22 is shown as visibly transparent at FIGS. 1-2 for the purposes of illustration.

As described above, the interconnect module 20 can be configured as an optical transceiver having both at least one transmit (Tx) optical channel such as a plurality of Tx channels, and at least one receive (Rx) optical channel such as a plurality of Rx channels. In other examples, the interconnect module 20 may be an optical transmitter having only transmit optical channels and no receive optical channels. In still other examples, the interconnect module 20 can be an optical receiver having only receive optical channels and no transmit optical channels. When the interconnect module 20 is a transmitter, the receive channels present in an optical transceiver may be replaced by a second set of transmit channels. When the interconnect module 20 is a receiver, the transmit channels present in an optical transceiver may be replaced by a second set of receive channels.

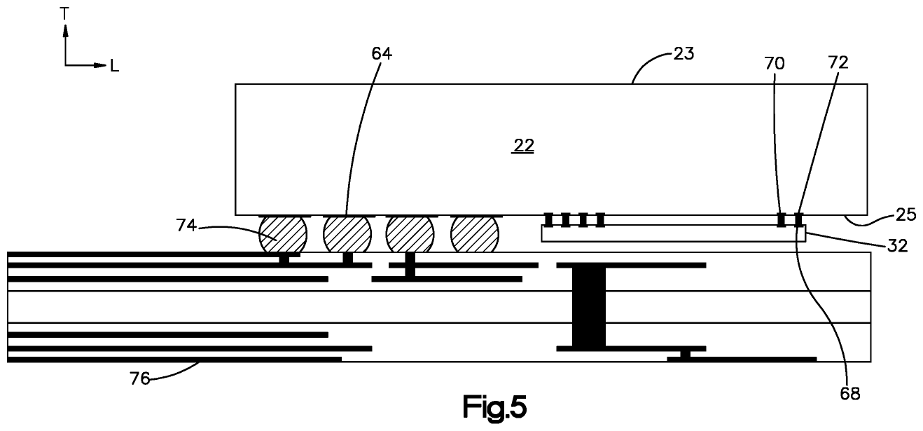

The base substrate 22 defines a first or top surface 23 and a second or bottom surface 25 opposite the first surface 23 along a transverse direction T. The first and second surfaces 23 and 25 define the major surfaces of the base substrate 22. The first and second surfaces 23 and 25 of the base substrate 22 may be oriented in respective planes that are oriented perpendicular to the transverse direction T. The planes can be defined by a longitudinal direction L that is perpendicular to the transverse direction T, and a lateral direction A that is perpendicular to each of the longitudinal direction L and the transverse direction T. The base substrate 22 can be configured to be mounted to a host substrate 76 so that the second surface faces the host substrate 76 (see FIG. 5). In particular, as is described in more detail below, the base substrate 22 can include a plurality of contact pads disposed at the second surface 25, including outer electrical contact pads 64 and inner electrical contact pads 70 (see FIG. 5). It should be appreciated that the first surface 23 and the second surface 25 can be referred to as top and bottom surfaces, respectively, when oriented as shown in FIG. 5, but the actual orientation of the interconnect assembly 20 can change during use. Thus, the directional terms “top” and “bottom” refer to positions along the transverse direction T and are not necessarily related to an orientation in a gravitational field. In this regard, the terms “top,” “upper,” “above,” and derivatives thereof as used herein refer to an upward direction from the second surface 25 of the base substrate 22 toward the first surface 23. Conversely, the terms “bottom,” “lower,” “below,” and derivatives thereof as used herein refer to a downward direction from the first surface 23 of the base substrate 22 toward the second surface 25.

Various elements may be mounted to either or both of the first surface 23 and the second surface 25 of the base substrate 22. Elements mounted to the base substrate 22 are offset from the base substrate 22 in the transverse direction T. Elements that are directly mounted to the base substrate 22 may include an IO (Input/Output)-Control ASIC (Application Specific Integrated Circuit, which may be a microcontroller) 26, a lens array 28, at least one modulator driver 30, a photonic integrated circuit (PIC) 32, such as a silicon photonics (SiPho) chip, a photodetector array 34, and a transimpedance amplifier 36. The PIC 32 can be configured to originate a plurality of transmit optical channels. Thus, transmit optical channels may originate in the PIC 32. In particular, the PIC 32 can perform an electrical-to-optical conversion of transmit data that passes through the interconnect module 20. The photodetector array 34 can be configured to receive and terminate a plurality of receive optical channels. Thus, receive optical channels may terminate in the photodetector array 34. In particular, the photodetector array 34 can perform an optical-to-electrical conversion of receive data passing through the interconnect module 20. In this regard, the PIC 32 and the photodetector array 34 can be referred to as optoelectronic elements. The PIC 32 and photodetector array 34 may be physically separate entities individually mounted to the second surface 25 of the base substrate 22. Advantageously this allows the PIC 32 and the photodetector array 34 to be individually optimized for their respective functions.

The IO-Control ASIC 26 and lens array 28 may be mounted to the first surface 23 of the base substrate 22. Electrically conductive vias may electrically connect the first surface 23 and the second surface 25 of the base substrate. Electrical signals to and from the IO-Control ASIC may propagate through these electrically conductive vias. The modulator driver 30, photonic integrated circuit 32, the photodetector array 34, and the transimpedance amplifier 36 may be mounted to the second surface 25 of the base substrate 22. In some embodiments, the IO-Control ASIC 26 may be located remotely from the base substrate 22, for example, on the host substrate 76 (see FIG. 5) and is thus not part of the interconnect module 20.

The interconnect module 20 can further include an isolator assembly 40 that can be mounted to a first or top surface 38 of the lens array 28. Thus, it can be said that the isolator assembly 40 can be supported by the first surface 23 of the base substrate 22. The first surface 38 of the lens array 28 can face away from the base substrate 22 when the lens array 28 is mounted to the base substrate 22. Thus, the lens array 28 can be disposed between the base substrate 22 and the isolator assembly 40 with respect to the transverse direction T.

The interconnect module 20 can include a first or top fiber assembly 42 that can include a first fiber ferrule 44 and a plurality of first optical fibers 48 supported by the first fiber ferrule 44. For instance, the first optical fibers 48 can extend into the first fiber ferrule 44 along the longitudinal direction L. At least a portion up to an entirety of the first fiber ferrule 44 can be transparent. The first optical fibers 48 can be configured as data transmission optical fibers. For instance, the first optical fibers 48 may be configured as receive optical fibers that deliver incoming receive optical signals to the interconnect module 20. The first fiber assembly 42 can further include a first fiber cable 60 that contains the plurality of first optical fibers 48. The first fiber cable 60 can be configured as a first ribbon cable in some examples. The first fiber ferrule 44 may terminate the first fiber cable 60, and thus the first optical fibers 48. The first fiber assembly 42 can be referred to as a receive fiber assembly, the first optical fibers 48 can be referred to as receive optical fibers, and the first fiber ferrule 44 can be referred to as a receive fiber ferrule, and the first fiber cable 60 can be referred to as a receive fiber cable.

The interconnect module 20 can further include a second or bottom fiber assembly 52 that can include a second fiber ferrule 56 and a plurality of second optical fibers 58 supported by the second fiber ferrule 56. For instance, the second optical fibers 58 can extend into the second fiber ferrule 56 along the longitudinal direction L. At least a portion up to an entirety of the second fiber ferrule 56 can be transparent. The second optical fibers 58 can be configured as data transmission optical fibers. In one example, the second optical fibers 58 may be configured as transmit optical fibers that carry outbound transmitted optical signals away from the interconnect module 20. Thus, the second fiber assembly 52 can be referred to as a transmit fiber assembly, the second optical fibers 58 can be referred to as transmit optical fibers, and the second fiber ferrule 56 can be referred to as a transmit fiber ferrule. The second fiber assembly 52 can further include a second fiber cable 62 that contains the plurality of second optical fibers 58. The second fiber cable 62 can be configured as a second ribbon cable in some examples. The second fiber ferrule 56 may terminate the second fiber cable 62, and thus the second optical fibers 58. The second fiber cable 62 can thus be referred to as a transmit fiber cable 62. As will be described in more detail below, the first fiber ferrule 44 can be mounted on the second fiber ferrule 56, which in turn is supported by the first surface 23 of the base substrate 22. Thus, it can be said that the first fiber ferrule 44 is supported by the first surface 23 of the base substrate 22. In one example, the first fiber ferrule 44 is mounted on a first surface of the second fiber ferrule 56 that faces away from the base substrate 22.

While the first fiber assembly 42 can support receive optical signals and the second fiber assembly 52 can support transmit optical signals as described above, the interconnect module 20 can be alternatively configured as desired. For instance, the first fiber assembly 42 can alternatively support transmit optical signals, and the second fiber assembly 52 can support receive optical signals. When the interconnect module 20 is a transmitter only, the interconnect module can be devoid of the fiber assembly that supports receive optical signals. In some examples, when the interconnect module 20 is a transmitter only, each of the first and second fiber assemblies 42 and 52 can support transmit optical signals. Conversely, when the interconnect module 20 is a receiver only, the interconnect module can be devoid of the fiber assembly that supports transmit optical signals. In some examples, when the interconnect module 20 is a receiver only, each of the first and second fiber assemblies 42 and 52 can support receive optical signals.

The first and second fiber assemblies 42 and 52 can be adjacent each other along the transverse direction T. For instance, the second fiber ferrule 56 may be mounted to a first or top surface 41 of the isolator assembly 40. The top surface 41 of the isolator assembly 40 can face away from the base substrate 22 when the isolator assembly 40 is mounted to the lens array 28 which, in turn, is mounted to the base substrate 22. Thus, the isolator assembly 40 can be disposed between the lens array 28 and the second fiber ferrule 56 with respect to the transverse direction T. The first fiber ferrule 44 may be mounted to a first or top surface of the second fiber ferrule 56. Thus, the second fiber ferrule 56 can be disposed between the isolator assembly 40 and the first fiber ferrule 44. In this regard, the first fiber assembly 42 can be referred to as a top fiber assembly, the first fiber ferrule 44 can be referred to as a top fiber ferrule, the plurality of first optical fibers 48 can be referred to as a plurality of top optical fibers, and the first fiber cable 60 can be referred to as a top fiber cable. The second fiber assembly 52 can be referred to as a bottom fiber assembly, the second fiber ferrule 56 can be referred to as a bottom fiber ferrule, the plurality of second optical fibers 58 can be referred to as a plurality of bottom optical fibers, and the second fiber cable 62 can be referred to as a bottom fiber cable. Each of the first fiber cables 60 and the second fiber cables 62 can have eight active optical fibers configured to receive and transmit data, respectively, in one example. The first fiber cables 60 can be arranged in a first row that is oriented along the lateral direction A. The second fiber cables 62 can be arranged in a second row that is oriented along the lateral direction A. Each cable may have any number of active fibers arranged in a respective row as desired so as to support transmit optical channels or receive optical channels. Additionally, as described below the first fiber cable 60 or the second fiber cable 62 may include one or more light delivery optical fibers that provide continuous wave (cw) light to the PIC 32. Thus, the second fiber assembly 52 can include the second optical fibers 58 and at least one delivery optical fiber. The lens array 28, isolator assembly 40, and first and second fiber ferrules 42 and 56 may be transparent at an operating wavelength of the interconnect module 20 such that light can propagate therethrough.

The base substrate 22 may have a plurality of electrical pads on both its first and second surfaces 23 and 25. In one example, the base substrate 22 can include one or more rows of outer electrical contact pads 64 arranged along the second surface 25 adjacent an edge of the base substrate 22. All edges of the base substrate 22 may have at least one row of outer electrical contact pads 64. The outer electrical contact pads 64 may be configured to make an electrical connection with a host substrate 76 (see FIG. 5). The electrical connection may be defined by a permanent connection using solder or the like, such as C4 (controlled collapse chip connection) solder bumps. The permanent electrical connection can define a ball grid array (BGA) in some examples. In other examples, the electrical connection can be defined by a separable electrical connection using an electrically conductive contact or the like.

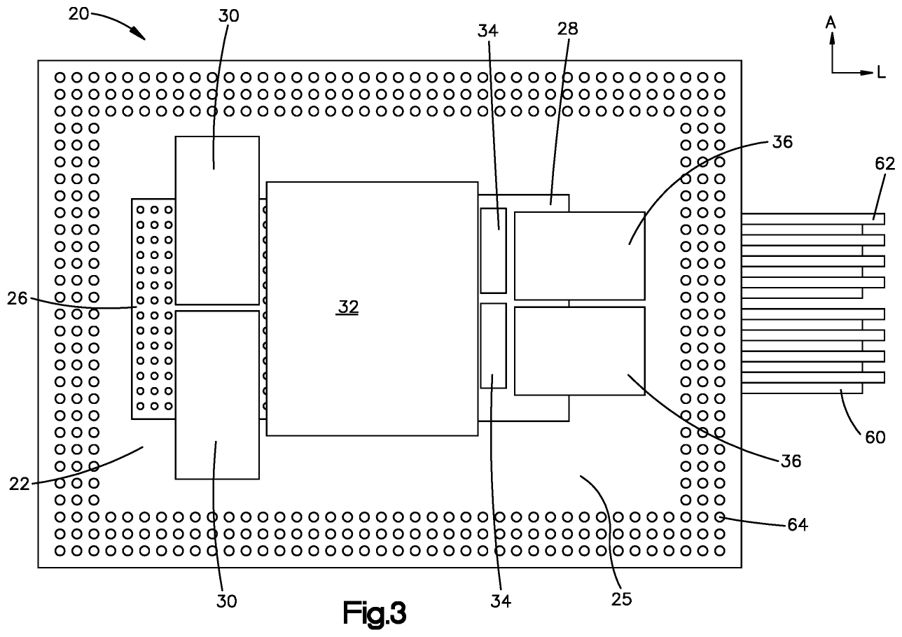

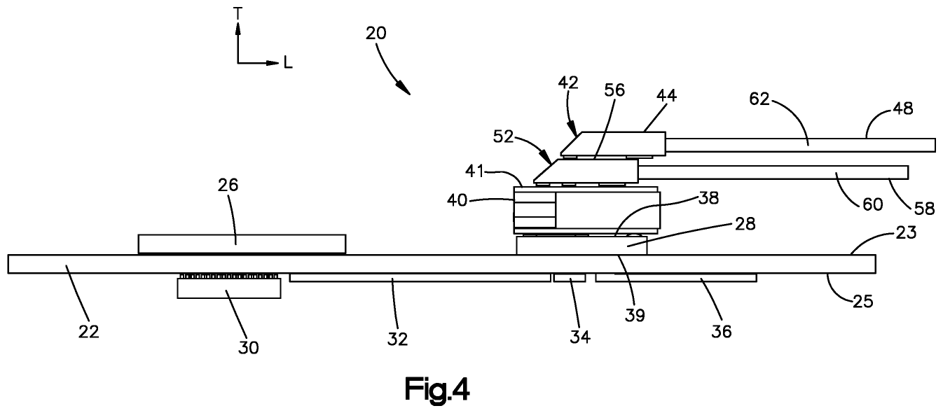

Referring to FIGS. 3-4, the interconnect module 20 can include at least one modulator driver chip 30 such as two modulator driver chips 30, at least one photodetector 34 array such as two photodetector arrays 34, and at least one transimpedance amplifier 36 such as two transimpedance amplifiers 36. The modulator driver chips 30, the photodetector arrays 34, and the transimpedance amplifiers 36 can be spaced apart from each other along the lateral direction A. The PIC 32 may be positioned between the modulator driver 30 and the photodetector array 34 along the longitudinal direction L. The photodetector arrays 34 can be positioned between the transimpedance amplifiers 36 and the PIC 32 along the longitudinal direction L. The photodetector array 34 may be a surface sensitive photodetector array 34 arranged to detect receive light striking the array at a normal or near-normal angle of incidence to the active detection areas of the array. As shown in FIG. 3, the IO-Control ASIC 26 may be positioned above the modulator driver 30 in the transverse direction T with the base substrate 22 positioned between them. Thus, the IO-Control ASIC 26 can be mounted to the first surface 23 of the base substrate 22, and the modulator driver 30 can be mounted to the second surface 25. The base substrate 22 can further be positioned between the PIC 32 and each of the IO-Control ASIC 26 and the lens array 28. In particular, the lens array 28 can be mounted to the first surface 23 of the base substrate 22, and the PIC 32 can be mounted to the second surface 25. Thus, a first longitudinal end of the PIC 32 may be positioned beneath the IO-Control ASIC 26 and second longitudinal end of the PIC 32 opposite the first end along the longitudinal direction L may be positioned beneath the lens array 28. Further, the first end of the PIC 32 can be aligned with the IO-Control ASIC 26 along the transverse direction T. The second end of the PIC 32 can be aligned with the lens array 28 along the transverse direction T. In some embodiments, the IO-Control ASIC 26 may not be part of the interconnect module 20 but may be remotely located. In other embodiments, the IO-Control ASIC may be located on the bottom surface 25 of the base substrate 22. An advantage of this example is that it may not require electrically conductive vias in the base substrate 22.

Referring now also to FIG. 5, the PIC 32 can be in electrical communication with the base substrate 22. In particular, the interconnect module 20 can include a plurality of electrical connections between the PIC 32 and the base substrate 22 that place the PIC 32 in electrical communication with the base substrate 22. In one example, the PIC 32 can include a plurality of PIC electrical contact pads 68 disposed at a top surface of the PIC 32, and the base substrate 22 can include a plurality of inner electrical contact pads 70 at the second surface 25. The PIC 32 may be mounted to the base substrate 22 with electrically conductive C2 (chip connection) bumps 72, such as bumps using copper pillars with a reflowable solder cap, that extend from respective ones of the PIC electrical contact pads 68 to respective ones of the inner electrical contact pads 70 of the base substrate 22, thereby placing the PIC 32 in electrical communication with the base substrate 22. The electrically conductive C2 bumps 72 are configured to allow for finer pitch electrical connections as compared to C4 solder bumps. Thus, the base substrate inner electrical contact pads 70 may have a finer pitch than the outer electrical contact pads 64. It should be appreciated, however, that the PIC 32 can be mounted to the base substrate 22 in any suitable alternative manner as desired.

The C4 solder bumps 74, which have no copper pillars, may be used to mount and electrically connect the base substrate 22 to a host substrate 76, thereby placing the base substrate 22 in electrical communication with the host substrate 76. It should be appreciated that the base substrate 22 and the host substrate 76 can be placed in electrical communication with each other in any suitable alternative manner as desired. The C2 contacts may be physically smaller than the C4 contacts, which may allow them to be more closely spaced. Voids present between the solder may be filled with an underfill material to increase the mechanical strength of the joint between the PIC 32 and base substrate 22. In the area of the PIC 32 aligned with the lens array 28 along the transverse direction T, at least of portion of the space between the PIC 32 and base substrate 22 may be filled with a transparent encapsulant or underfill material. This transparent encapsulant or underfill material may be used over the entire area between the PIC 32 and the base transparent substrate 22 or over only that portion that is aligned with the lens array 28 along the transverse direction, where an optical path for the Tx and Rx channels is located.

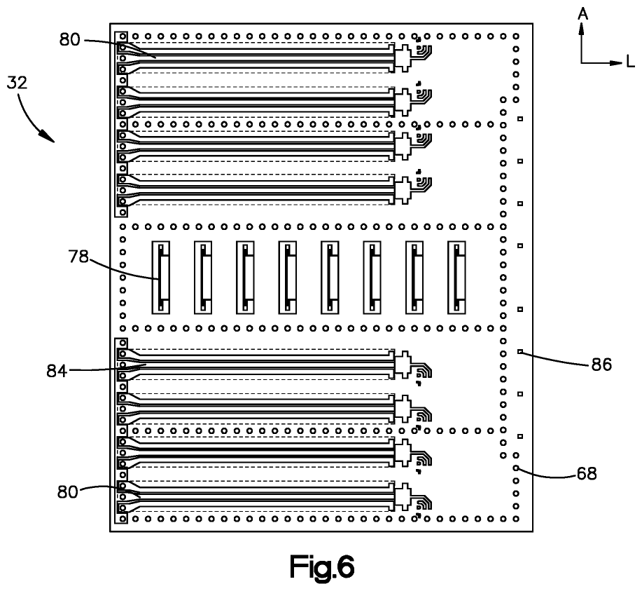

Referring now to FIG. 6, the PIC 32 may be formed on a III-V or II-VI semiconductor substrate, or can alternatively be configured as a silicon photonics (SiPho) chip. The PIC 32 may be arranged to support a plurality of transmit (Tx) channels. The PIC 32 may have no receive (Rx) channels in some examples. In other examples, the PIC 32 can have Rx channels in place of the photodetector array 34. Each of the plurality of Tx channels may have an associated light source such as a laser 78. In some examples an output of a single light source or laser 78 may be split into a plurality of Tx channels that each have an associated modulator 80. Thus, in some examples, a single laser may supply optical power for some, up to all, the Tx channels. In other examples, a plurality of light sources of lasers 78 can supply optical power for one or more of the Tx channels. Each laser 78 may be integrated with the PIC 32 in a unitary manner. For example, each laser 78 may be formed on an InP-vignette or chiplet, which is permanently bonded to a top surface of a SiPho chip. Alternatively, if the PIC 32 is formed in a III-V or II-VI substrate the lasers may be formed directly on the substrate by epitaxial growth. FIG. 6 shows the PIC 32 having eight lasers 78 but there may be a smaller or larger number of lasers. The lasers 78 may emit continuous wave (cw) light which is coupled into an optical waveguide of the PIC 32. For instance, the optical waveguide can be formed on a top surface of the PIC 32 that faces the base substrate 22.

In another example, the light source or laser 78 may be remotely located from the PIC 32 and the emitted light delivered to the PIC 32 over a light delivery optical fiber. Thus, the light delivery optical fiber can supply optical power to an optical transmitter, and in particular to the PIC 32. The optical transmitter can be included in an optical transceiver, or can be a stand-alone optical transmitter. The light delivery optical fiber may be a polarization preserving optical fiber to help maintain a fixed polarization input into the PIC 32. Alternatively, the PIC 32 may be configured to accept an arbitrary incoming light polarization. For example, the PIC 32 may be able to sense an incoming light polarization and rotate the light polarization in the PIC 32 to provide a light polarization suitable for the modulators 80. The light delivery optical fiber may be supported by the bottom fiber ferrule 56, the top fiber ferrule 44, or it may be supported by a separate ferrule. In this regard, a fiber system can include the first fiber assembly 42 and the second fiber assembly 52, wherein at least one of the first and second fiber assemblies 42 and 52 can include at least one light delivery optical fiber and data transmission optical fibers. The at least one light delivery optical fiber can be included in at least one of the fiber cables 60 and 62. Alternatively, the at least one light delivery optical fiber can be separate from at least one of the first fiber cables 60 and the second fiber cables 62. In still other examples, the at least one light delivery optical fiber can be separate from the first and second fiber assemblies 42 and 52.

Thus, the light delivery optical fiber can be configured as shown at FIG. 1 with respect to any one of the first and second optical fibers 48 and 58, with the exception that the light delivery optical fiber delivers optical power to the PIC 32. The optical delivery optical fiber may be identical to the optical fibers used to transmit and receive data, or the optical delivery optical fiber may be different to the data propagating fibers. The light source such as a laser 78 can emit light into a first end of the light delivery optical fiber. The light can travel along the light delivery optical fiber to an opposed second end of the light delivery optical fiber which can be optically aligned with the PIC 32, such that the light is delivered to the PIC 32. Incorporating the light delivery optical fiber into either the first fiber assembly 42 or the bottom fiber assembly 52 has an advantage of simultaneous alignment of the light delivery optical fiber and other optical fibers in those assemblies with the PIC 32. In some examples, there may be more than one light delivery optical fiber supplied by one or more remote light sources, which may improve the reliability of the interconnect module 20 by having multiple independent light sources delivering light to the PIC 32. The remote light sources can be supported by the host substrate 76 (see FIG. 5) or any suitable alternative structure that can be remote from the interconnect module 20 and the host substrate 76 as desired. The light delivery optical fiber can be arranged so that light propagating towards the PIC 32 does not pass through an optical isolator, which could greatly reduce delivered light to the PIC 32.

With continuing reference to FIG. 6, the PIC 32 can include one or more modulators 80. Thus, independent of whether the one or more light sources powering the PIC 32 are integral with the PIC 32 or located remotely from the PIC 32, the emitted light from each light source may be guided into a respective modulator 80. The modulator 80 may take one of many forms, such as a Mach-Zehnder modulator, a microring modulator, or an electro-absorption modulator. The modulator 80 may be Mach-Zehnder modulator 84 having a traveling wave electrode structure with a first traveling wave electrode and a second traveling wave electrode. A central ground electrode may be situated between the first traveling wave electrode and second traveling wave electrode. The central ground electrode, first traveling wave electrode, and second traveling wave electrode may be oriented in the longitudinal direction. A first arm of the Mach-Zehnder modulator 84 may be situated between the central ground electrode and the first traveling wave electrode. A second arm of the Mach-Zehnder modulator may be situated between the central ground electrode and the second traveling wave electrode. A first outer ground electrode may be situated outboard of the first traveling wave electrode, such that the first traveling wave electrode is disposed between the first outer ground electrode and the first arm (and thus also the central ground electrode). A second outer ground electrode may be situated outboard of the second traveling wave electrode, such that the second traveling wave electrode is disposed between the second outer ground electrode and the second arm (and thus also the central ground electrode). Both outer ground electrodes may be on an opposed side of the traveling wave electrodes relative to the central ground electrode. The electrodes thus form a G-S-G-S-G pattern, in which G represents a ground electrode and S represents a signal electrode. The outer electrodes may only extend a short distance in the lateral direction A.

As noted above the modulator 80 may take many forms, such as, but not limited to, a microring modulator or an electro-absorption modulator. An advantage of these types of modulators over a Mach-Zehnder modulator is that they may be smaller in size allowing the PIC 32 substrate to be smaller. For example, the PIC 32 may have a footprint smaller than 10 mm×10 mm along a plane oriented along the longitudinal direction L and the lateral direction A, thereby allowing many devices to be fabricated from a single wafer.

The PIC 32 may also include a plurality of heaters. One heater may be associated with each modulator 80. Each heater may be used to differentially heat one of the arms of an associated Mach-Zehnder modulator 80 and thereby adjust a bias point of the modulator 80. For example, the heat may be controlled so that with no applied electric field between the traveling wave electrodes, the modulator 80 is in a digital “1” state transmitting the incident light. Application of an electric field between the traveling wave electrodes will result in a differential phase shift between the arms, reducing the transmitted power through the modulator 80 and allowing generation of a digital “0” state. In other embodiments, the heater may be used to bias the modulator 80 to a digital “0” with no applied voltage and a digital “1” with applied voltage. The heater may be used to adjust the bias point of the modulator 80 to any desired position.

The PIC 32 may also include a plurality of surface grating couplers 86. One surface grating coupler 86 may be associated with each transmit (Tx) channel. Each surface grating coupler 86 terminates an optical waveguide and couples light traveling in the waveguide out of the top surface of the PIC 32. In an alternative embodiment, turning mirrors may be used to couple Tx light out of the PIC 32 instead of a surface grating coupler 86. The turning mirrors may be fabricated by removing material from the PIC 32 such that light traveling in a waveguide is directed out of the top surface of the PIC 32 by total internal reflection. Such an arrangement may be especially useful if the PIC 32 substrate is InP.

As described earlier, the PIC 32 may include the plurality of PIC electrical contact pads 68 located on the top surface of the PIC 32. The PIC electrical contact pads 68 may be arranged in an array that can include a plurality of rows oriented along the longitudinal direction L and spaced from each other along the lateral direction. The array can also include one or more columns oriented along the lateral direction A. In one example, an outer perimeter of the array can be defined by outermost ones of the rows and outermost ones of the columns. The rows may span a length of the PIC 32. The columns can define a width of the PIC 32. Each PIC electrical contact pad 68 may be configured to attach to a respective one of the inner electrical contact pads 70 on the base substrate 22. The rows may be arranged in a rectangular grid such that some rows are perpendicular to other rows. The PIC electrical contact pads 68 provide for electrical connections to and from the PIC 32 and provide mechanical support to help maintain planarity of the PIC 32 with respect to the base substrate 22.

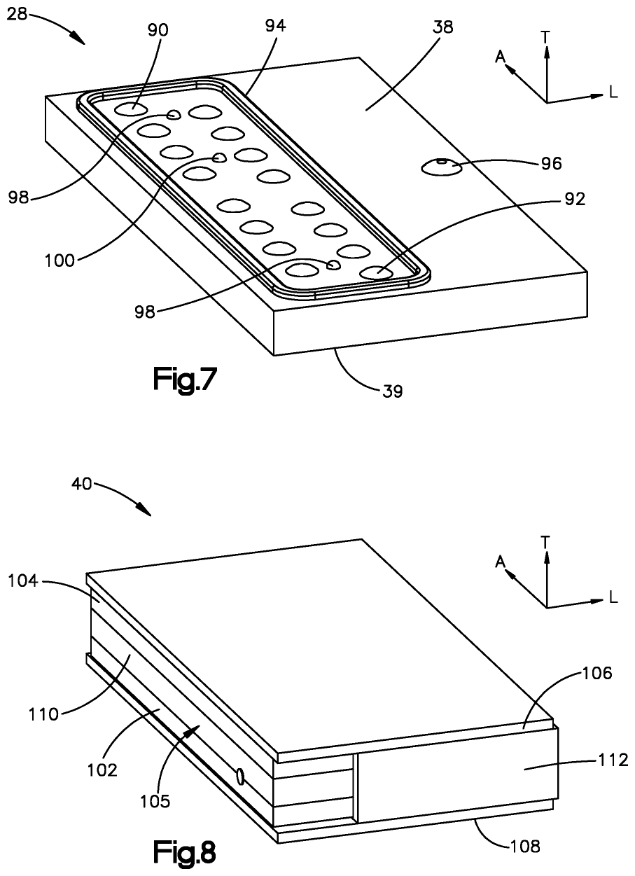

Referring now to FIG. 7, the lens array 28 may have a number of features formed on a first or top surface 38 of the lens array 28 that faces away from the base substrate 22. These features may include a plurality of Tx lenses 90, a plurality of Rx lenses 92, a dam 94 surrounding the Tx and Rx lenses 90 and 92, and a leveling support 96. Thus, all of the Tx lenses 90 and all of the Rx lenses 92 can be surrounded by the dam 94. The leveling support 96 may be spaced from the dam 94 in the longitudinal direction. The dam 94 and the leveling support 96 may have a substantially equal height (i.e., within manufacturing tolerance) off the top surface 38 of the lens array 28. The Tx and Rx lenses 90 and 92 may be arranged along a Tx lens row and a Rx lens row, respectively, that each extends along the lateral direction A. The Tx lens row and Rx lens row may be offset from each other along the longitudinal direction L. There may be a single row of Tx lenses 90 and a single row of Rx lenses 92 as depicted in FIG. 7. All the Tx lenses 90 may have the same optical power as each other and all the Rx lenses 92 may have the same optical power as each other. The optical power of the Tx lenses 90 may be different than the optical power of the Rx lenses 92 or the optical power of all lenses may be substantially identical (i.e., within manufacturing tolerances). The top surface 38 of the lens array 28 is configured to mate with a bottom surface of the isolator assembly 40 (see FIG. 4). The bottom surface of the isolator assembly 40 may be secured to the top surface 38 of the lens array 28 using any suitable attachment member as desired, such as optically transparent adhesive. The dam 94 prevents the adhesive from entering an area inside the dam 94 where the Tx and Rx lenses 90 and 92 are located. Thus, the dam 94 prevents the adhesive from contacting the lenses and altering their optical properties. Also located within the area of the top surface 38 of the lens array 28 enclosed by the dam 94 may be one or more fiducial marks 98 to facilitate alignment of the lens array 28 with respect to the PIC 32 underlying the base substrate 22. In one example, the fiducial marks 98 can be arranged along a row that is disposed between the Tx lens row and Rx lens row. It should be appreciated that the fiducial marks 98 can be alternatively positioned as desired. Additionally located within the area of the top surface 38 of the lens array 28 enclosed by the dam 94 may be a labeling feature 100. The labeling feature 100 may contain information regarding a revision code that identifies the model of the lens array 28.

The lens array 28 defines a bottom surface 39 that is opposite the top surface 38 along the transverse direction T. The bottom surface 39 of the lens array 28 may be configured to be mounted on the first surface 23 of the base substrate 22 (see FIG. 4). The bottom surface 39 of the lens array 28 may have a plurality of small protrusions located outside any Tx or Rx optical path. The protrusions may help to reduce or prevent the formation of gas bubbles in an adhesive that attaches the bottom surface 39 of the lens array 28 to the base substrate 22.

Referring now to FIG. 8, the isolator assembly 40 may include an optical isolator that is configured to minimize any backward propagating light in the Tx optical channel from producing undesirable feedback in the PIC 32, which may destabilize its operation. The isolator assembly 40 can include an optical spacer 112 and an optical isolator that can be configured as a polarizer/polarization rotator stack 105 as will be described in more detail below. The polarizer/polarization rotator stack 105 can include a non-reciprocal polarization rotator 110 positioned between a first polarizer 102 oriented at 0° and a second polarizer 104 oriented at 45°. For instance, the polarization rotator 110 can be disposed between the first and second polarizers 102 and 104 along the transverse direction T. The polarizers 102 and 104 and the polarization rotator 110 may thus form the polarizer/polarization rotator stack 105. The orientation of the 0° first polarizer 102 may match an output polarization of the PIC 32, so that substantially all of the light output by the PIC 32 passes through the first polarizer. The isolator assembly 40 can also include a first or top optical plate 106 and a second bottom optical plate 108 opposite the top optical plate 106 along the transverse direction T. The polarizer/polarization rotator stack 105 may be positioned between the top and bottom optical plates 106 and 108. Thus, the top and bottom plates 106 can be configured to retain the polarizer/polarization rotator stack 105 in position. In other examples, the elements of the polarizer rotator stack 105 can be held together by adhesive or any suitable alternative fastener as desired. The isolator assembly 40 can also include an optical block. In one example, the optical block can be configured as an optical spacer 112 that extends from the top optical plate 106 to the bottom optical plate 108. The optical spacer 112 can be spaced from the stack 105 along the longitudinal direction L. The optical spacer 112 may have the same height as that of the polarizer/polarization rotator stack along the transverse direction T. The optical spacer 112 may have an index of refraction substantially equal to the effective index of refraction of the polarizer/polarization rotator stack 105. For example, the refractive index of the optical spacer 112 may be within 5%, such as within 2%, such as within 1%, of the net refractive index of the polarizer/polarization rotator stack 105. Because the height and effective refraction index of the optical spacer 112 and the polarizer/polarization rotator stack 105 are substantially equal to each other, a receive channel optical path length through the optical spacer can be substantially equal to a transmit channel optical path length through the polarizer/polarization rotator stack. In one example, the optical block or optical spacer 112 can be made of glass or any suitable alternative material that is optically transparent with respect to the propagation of the optical paths that extend therethrough.

In operation light in a Tx channel passes through the bottom optical plate 108, which is transparent at the operating wavelength of the interconnect module 20. The Tx channel light may be polarized at approximately 0° so it is passed by the first polarizer 102 oriented at 0°. The Tx channel light then has its polarization rotated by 45° as it propagates through the polarization rotator 110. The second polarizer 104 oriented at 45° thus passes the Tx light, which then proceeds to propagate through the top optical plate 106. Any light attempting to propagate downward through the polarizer/polarization rotator stack is blocked, reducing or eliminating feedback into the PIC 32 which may deleteriously impact its operation. Thus, light in a Tx channel can be prevented from producing feedback that travels back to the PIC 32. Light in a Rx channel may pass through the optical spacer 112 and thus may avoid the polarizer/polarization rotator stack.

In some examples, the interconnect module 20 can be devoid of the isolator assembly 40. For instance, in some examples optical feedback to the PIC 32 may not deleteriously impact its operation. In this case, the interconnect module 20 can include an expanded optical block that can be expanded with respect to the optical block configured as an optical spacer 112. The expanded optical block can replace the first polarizer 102, the second polarizer 104, the polarization rotator 110, the top bottom optical plate 106, and the bottom optical plate 108. Thus, the optical block can be taller along the transverse direction T than the optical spacer 112 so that it extends from the second fiber ferrule 56 to the lens array 28. The optical block can also be longer along the longitudinal direction L than the optical spacer 112 so that it extends to a location aligned with the Tx optical path 128a so that the Tx optical path 128a travels through the optical block from the lens array 28 to the second fiber ferrule 56. An advantage of this arrangement is that all other elements of the interconnect module 20 may remain identical, and the isolator assembly 40 can be used or replaced with the expanded optical spacer 112 as desired. The expanded optical block can have the same thickness as the isolator assembly 40. This allows the interconnect module 20 to incorporate the isolator assembly 40 or the expanded optical spacer 112 without adjusting the optical power of any optical surfaces in the interconnect module 20. When the isolator assembly 40 is replaced with the expanded optical spacer, light in the Rx channel can pass through the optical spacer as described above. Further, when the isolator assembly 40 is replaced by the expanded optical spacer 112, light in the Tx channel can also pass through the expanded optical spacer 112. In still other examples, the isolator assembly 40 can be eliminated without directing light of the Tx channel through the optical spacer. Rather, the second fiber ferrule 56 can be mounted directly to the lens array 28.

The optical power of the lenses in the lens array 28 can be adjusted to compensate for the shorter optical path between the lens array 28 and the first and second fiber ferrules 44 and 56.

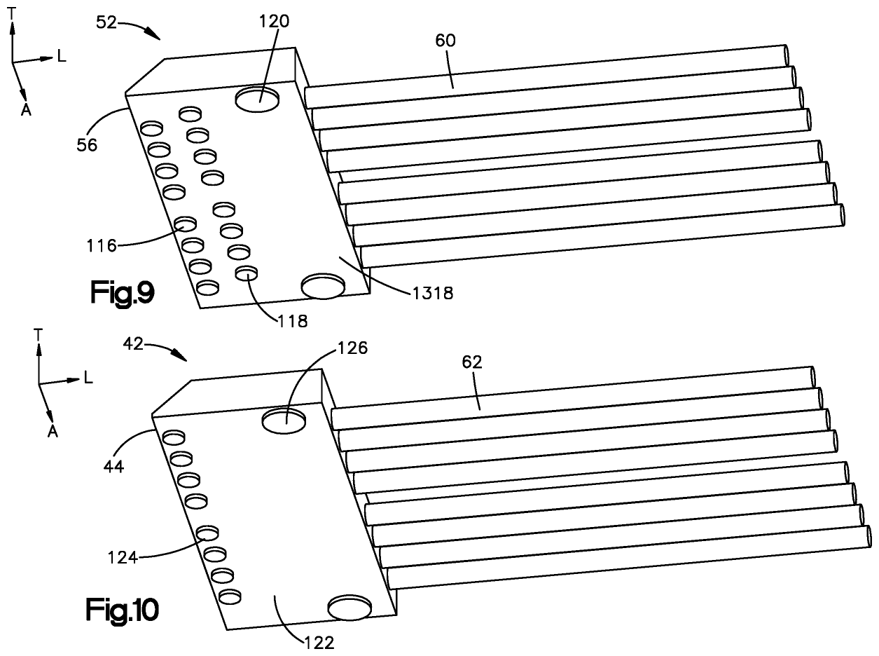

Referring now to FIG. 9, the bottom fiber assembly 52 may include the bottom fiber ferrule 56 as described above, which terminates a bottom fiber cable 62. The bottom fiber cable 62 may be a ribbon cable having a plurality of optical fibers. For example, the ribbon cable may have twelve optical fibers. On a bottom surface of the bottom fiber ferrule 56 that faces toward the base substrate 22 there may be a plurality of protrusions. The plurality of protrusions may include a plurality of Tx protrusions 116, a plurality of Rx protrusions 118, and a leveling protrusion 120. The Tx protrusions 116 are arranged so that a Tx optical channel may pass through a Tx protrusion 116. Similarly, the Rx protrusions 118 are arranged so that a Rx optical channel may pass through a Rx protrusion 118. The Tx and Rx protrusions 116 and 118 may be offset from each other in the longitudinal direction and be interleaved with each other in the lateral direction. The Tx and Rx protrusions 116 and 118 may extend the same distance from the bottom surface of the bottom fiber ferrule 56. The leveling protrusion 120 may be two leveling protrusions 120 and may be spaced from the Tx and Rx protrusions 116 and 118 in the longitudinal direction. The leveling protrusions 120 may extend the same distance above the bottom surface as the Tx and Rx protrusions 116 and 118.

The bottom surface of the bottom fiber ferrule 56 may be mounted to the top surface of the top optical plate 106 of the isolator assembly 40. The surfaces may be joined using a transparent adhesive. An advantage of positioning the Tx and Rx protrusions 116 and 118 in the light paths of the Tx and Rx channels, respectively, is that they minimize occurrence of air bubbles in the adhesive in the light paths. The leveling protrusions work in concert with the Tx and Rx protrusions 116 and 118 to orient the bottom surface of the bottom fiber ferrule 56 so that it is substantially parallel with the top surface of the top optical plate 106.

FIG. 10 shows a perspective view of the top fiber assembly 42. The top fiber assembly 42 may include the top fiber ferrule 44, which terminates a top fiber cable 60. The top fiber cable 60 may be a ribbon cable having a plurality of optical fibers. For example, the ribbon cable may have twelve optical fibers. On a bottom surface 122 of the top fiber ferrule 44 that faces toward the base substrate 22 there may be a plurality of protrusions. The plurality of protrusions may include a plurality of Rx protrusions 124 and at least two leveling protrusions 126. The Rx protrusions 124 are arranged so that a Rx optical channel may pass through a Rx protrusion 124. The Rx protrusions 124 on the top fiber ferrule 44 may be identical to the Rx protrusions 118 on the bottom fiber ferrule 56. The at least two leveling protrusions 126 may extend the same distance above the bottom surface 122 as the Rx protrusions 124.

The bottom surface 122 of the top fiber ferrule 44 may be mounted to a top surface of the bottom fiber ferrule 56. The surfaces may be joined using a transparent adhesive. An advantage of positioning the Rx protrusions 124 in the light path of the Rx channels is that they minimize occurrence of air bubbles in the adhesive in the light paths. The leveling protrusions 126 work in concert with the Rx protrusions 124 to orient the bottom surface 122 of the top fiber ferrule 44 so that it is substantially parallel with the top surface of the bottom fiber ferrule 56.

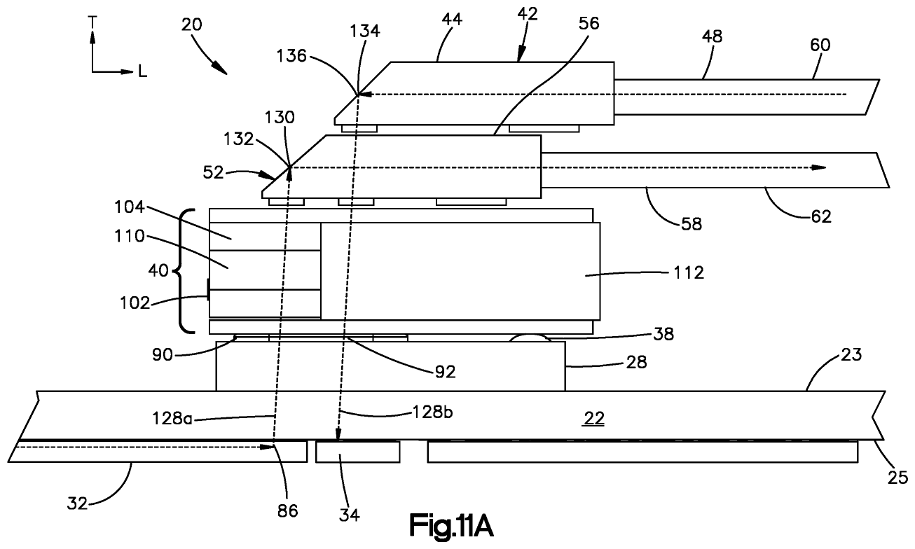

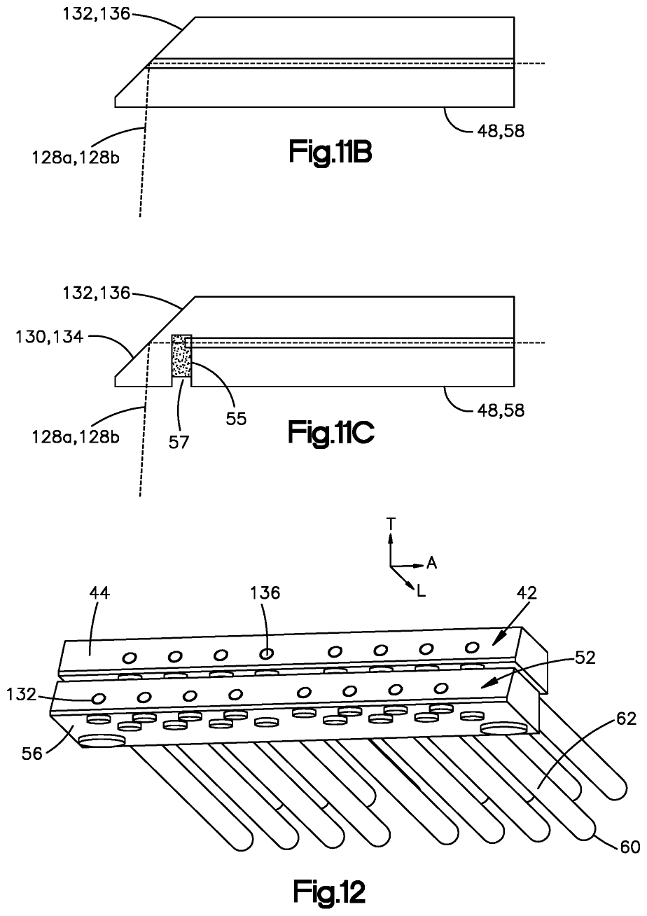

FIG. 11A shows the interconnect module 20 including a transmit channel (Tx) optical path 128a and a receive channel (Rx) channel optical path 128b. The Tx channel path 128a shown may represent one of a plurality of Tx channel optical paths that are spaced from each other and aligned with each other along the lateral direction A. The photonic integrated circuit (PIC) 32 is mounted on the bottom surface of the base substrate 22 and originates the at least one Tx optical path 128a. In particular, the Tx channel optical path 128a may originate in an optical waveguide of the photonic integrated circuit 32. In some examples, the optical waveguide that originates the Tx optical path 128 can be disposed along a top surface of a photonic integrated circuit 32. The optical waveguide can guide the Tx light while it is in the PIC 32. The PIC 32 can further include a surface grating coupler 86 that is configured to direct Tx light out of the optical waveguide. In particular, the surface grating coupler 86 can be configured to deflect the Tx light out of the optical waveguide. Alternatively, the PIC 32 can support a mirror that deflects the Tx light out of the PIC 32. The Tx light may leave the PIC 32 at an oblique angle with respect to a direction normal to both the top surface and the bottom surface of the PIC 32, which can be defined by the transverse direction T. In one example, the oblique angle can be approximately 7°. The Tx channel optical path can exit out the top surface of the PIC 32.

After leaving the PIC 32, the Tx channel optical path 128a may extend through the base substrate 22. After leaving the first surface 23 of the base substrate 22, the Tx channel optical path 128a may extend through the lens array 28. The Tx lens 90 on the top surface of the lens array 28 may focus the Tx light as it exits the lens array 28. After leaving the lens array 28, the Tx channel optical path 128a may extend through the isolator assembly 40 as described above. After leaving the isolator assembly 40, the Tx channel optical path 128a extends into the second fiber ferrule 56. In one example, the Tx channel optical path 128 exits the isolator assembly 40 out the top surface of the isolator assembly 40.

In the second fiber ferrule 56, the Tx channel optical path 128a is incident on a second or bottom ferrule reflector 130. As shown at FIGS. 11A-11B, the second fiber ferrule reflector 130 may be formed on a canted end face 132 of a second fiber. The canted end face 132 may be formed by polishing the second fiber ferrule at a canted angle with the second fibers secured in the second fiber ferrule 56. The canted end faces 132 of the transmit optical fibers may thus form a portion of an outer surface of the second fiber assembly 52. The canted end faces 132 are a reflective surface on the second fiber assembly that forms the second ferrule reflector 130. The second ferrule reflector 130 may be a total internal reflection surface or it may be an optically coated surface, such as a gold coated surface. The second ferrule reflector 130 redirects the Tx channel optical path 128a into a second fiber of the second fiber cable 62. The second fiber may be a single mode optical fiber. The second fiber may be oriented so that it is parallel to the top surface of the PIC 32 along the longitudinal direction. All of the Tx channel optical paths 128a may be arranged so that they are disposed in the second fibers of the second fiber cable 62.

With continuing reference to FIGS. 11A-11C, the Rx channel optical path 128b may be parallel to the Tx channel optical path 128a but spaced from the Tx optical path. The Rx channel optical path 128b shown may represent one of a plurality of Rx channel optical paths. The Rx channel optical paths 128b can be spaced from each other and aligned with each other along the lateral direction A. The Rx channel optical path 128b has an opposed propagation direction relative to the Tx channel optical path 128a. The Rx channel optical path 128b can begin in the first optical fiber 48 of the first fiber cable 60. The first optical fiber 48 may be a single mode optical fiber.

As shown at FIGS. 11A-B, the first optical fiber 48 can terminate at a first or top ferrule reflector 134, which redirects the Rx channel optical path 128b downwards as the Rx channel is received by the interconnect module 20. The first fiber ferrule reflector 134 may be formed on a canted end face 136 of a first fiber ferrule 44. The first fiber ferrule reflector 134 can be a top ferrule reflector in some examples. The canted end face 136 may be formed by polishing the first fiber ferrule 44 at a canted angle with the first optical fibers 48 secured in the first fiber ferrule 44. The canted end faces 136 of the first fiber ferrule 44 may thus form a portion of an outer surface of the first fiber assembly 42. The canted end faces 136 are a reflective surface on the first fiber assembly 42 that forms the first ferrule reflector 134. The first ferrule reflector 134 may be a total internal reflection surface or it may be coated with an optically reflective material, such as a gold or any suitable optically reflective material as desired. The Rx channel optical path 128b extends through the first fiber ferrule 44. After leaving the first fiber ferrule 44, the Rx channel optical path 128b can extend through the second fiber ferrule 56. In one example, the Rx channel optical path 128b can exit the first fiber ferrule 44 at the bottom surface of the first fiber ferrule 44.

As also shown at FIG. 3, the Rx channel optical paths 128b in the first fiber ferrule 44 of the first cable 60 can be offset with respect to Tx channel optical paths 128a in the second fiber ferrule 56 of the second cable 62, for instance along the lateral direction A, such that the Rx channel optical paths 128b are alternatingly arranged or interleaved with the Tx channel optical paths 128b. Thus, while the Tx and Rx channel optical paths 128a and 128b shown at FIGS. 11A-11B each pass through the bottom fiber ferrule 56, the optical paths do not intersect since the Rx channel optical paths 128b are offset from the Tx channel optical path 128a in the lateral direction. Accordingly, respective first straight lines that extend through the Tx channel optical paths 128a are spaced from respective second straight lines that extend through the Rx channel optical paths 128b at locations whereby the respective optical fibers 48 and 58 enter and are disposed in their respective ferrules 44 and 56. The first and second straight lines can be oriented along the transverse direction T or can be canted relative to the transverse direction.

Referring now to FIG. 11A, after exiting the second fiber ferrule 56, the Rx channel optical path 128b extends through the isolator assembly 40. In one example, the Rx channel optical path 128b exits the second fiber ferrule 56 through the bottom surface of the second fiber ferrule 56. It is appreciated that the Rx channel optical path 128b experiences no polarization rotation as it travels through the isolator assembly 40, since it passes through the optical spacer 112 and does not pass through the non-reciprocal polarization rotator 110. The Rx channel optical path 128 can exit the isolator assembly 40 from the bottom surface of the isolator assembly 40. After exiting the isolator assembly 40, the Rx channel optical path 128b may strike a Rx lens 92 of the lens array 28. The Rx lens 92 can be disposed on the top surface 38 of the lens array 28. The Rx lens 92 on the top surface 38 of the lens array 28 can be configured to focus the light of the Rx channel optical path 128. The Rx channel optical path 128b extends through the lens array 28. In one example, the Rx channel optical path 128b exits the lens array 28 from the bottom surface of the lens array 28. After exiting the lens array 28, the Rx channel optical path 128b extends through the base substrate 22. In one example, the Rx channel optical path 128b exits the base substrate 22 through the bottom surface of the base substrate 22. After passing through the base substrate 22, the Rx channel optical path 128b extends to the photodetector array 34, which can be mounted to the base substrate 22. The Rx channel optical path 128b may terminate at the photodetector array 34. As shown in FIGS. 11A-C the Rx channel optical path 128b may strike the photodetector array 34 at an oblique angle of incidence, which helps to reduce feedback into the Rx channel optical path 128b. Thus, all of the Rx channel optical paths 128b arranged at an oblique angle relative to either or both of a surface of the photodetector array 34 that faces the base substrate 22 and a surface of the photodetector array 34 that faces away from the base substrate 22. All of the Rx channel optical paths 128b may be arranged so that they are disposed in the first optical fibers of the first fiber cable 60 in one example, but other configurations are envisioned as described above.

Referring now to FIGS. 11A and 11C, in another example, the end faces of the receive optical fibers 48 and the transmit optical fibers 58 need not extend all the way to an outer surface of the respective optical fiber ferrules 44 and 56 that support them. Instead the receive and transmit optical fibers 48 and 58 may terminate within their respective ferrules 44 and 56 at a location spaced from the respective outer surfaces along the longitudinal direction L. Further, the receive and transmit optical fibers 48 and 58 can have respective end faces that are oriented along respective planes that are perpendicular or substantially perpendicular (i.e., within 20 degrees, such as within 15 degrees, such as within 10 degrees, such as within 5 degrees) to their respective longitudinal axes that can be oriented along the longitudinal direction L. As a result, the second ferrule reflector 130 and the first ferrule reflector 134 may each be a continuous surface, which may be easier to fabricate than a surface with exposed fiber end faces. An index matching material 55, such as a gel or adhesive, or the like may be disposed in at least a portion up to an entirety of a gap 57 between an end face of the first and second optical fibers 48 and 58, and an inner surface of their respective fiber ferrules 44 and 56. In one example, one or more openings can be formed in respective outer surfaces of the first and second fiber ferrules 44 and 56, for instance in the bottom surfaces of the ferrules. The openings can extend to a location aligned with the end faces of the respective optical fibers 48 and 58 so as to define the gaps 57. The index matching material 55 can be delivered into the gaps 57 through the openings. Thus, the reflective surfaces can be defined by the inner surface of the fiber ferrules 44 and 56.

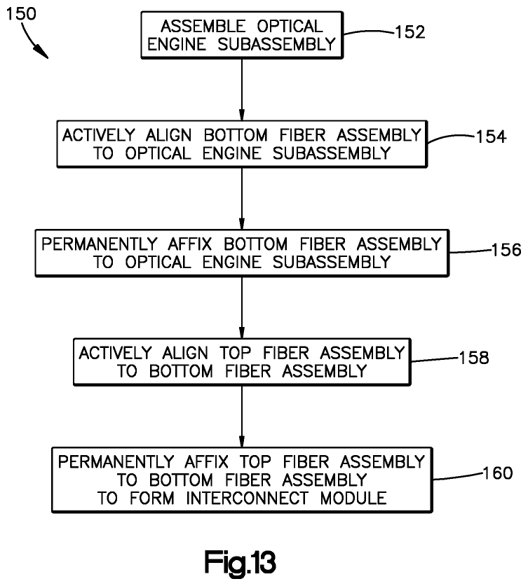

Referring now to FIG. 12, the first fiber assembly 42 can be mounted to the second fiber assembly 52. The first optical fibers 48 and the second optical fibers 58 may be arranged along respective first and second rows in their respective fiber ferrules, each row being oriented along the lateral direction A. The first and second rows can be spaced from each other along the transverse direction T. Each of the first and second rows may be divided into respective groups of fibers. The groups of fibers of the first and second rows can be separated by a common distance from each other or different distances from each other. In one example, each of the first and second rows can each define two respective groups of fibers. Thus, each group of fibers can be composed of four fibers. The groups of first optical fibers 48 may be associated with a different respective photodetector arrays 34 and different respective transimpedance amplifiers 36. Similarly, the groups of second optical fibers may be associated with different respective modulator drivers. These groupings are by way of example only, and different groupings may be used.

Referring now to FIG. 13, a method of assembling 150 the interconnect module 20 may begin at step 152 whereby all elements of the interconnect module 20 except the top and bottom fiber assemblies 42 and 52, respectively, can be assembled so as to define a subassembly. This subassembly can be described as an optical engine subassembly. At step 154, the second fiber assembly 52, containing the Tx optical channels may be actively aligned with the optical engine subassembly. At step 156, the second fiber assembly 52 may be permanently affixed to the optical engine subassembly. At step 158, the first fiber assembly 42, containing the Rx optical channels, may be actively aligned to the first fiber assembly 52. At step 160, the first fiber assembly 42 may be permanently affixed to the second fiber assembly 52 forming the interconnect module 20 in one example (see FIG. 1). For instance, the first fiber assembly 42 can be permanently affixed to a surface of the second fiber assembly 52 that faces away from the optical engine subassembly. It should be appreciated that steps 154-160 can be performed in any order as desired.

In other words, the method proceeds by actively aligning the second fiber assembly 52 such that the second optical fibers 58 are aligned with respective regions of the PIC 32. Thus, all of the active second optical fibers 58 are aligned with optical paths originating from the surface grating couplers 86 on the PIC 32 so as to maximize optical coupling efficiency between the second fiber assembly 52 and the PIC 32 (see FIG. 11A). The second fiber assembly 52 may be aligned, in the lateral, transverse and longitudinal directions and rotationally about each of these directions. Having these six degrees of adjustment freedom helps enable efficient coupling simultaneously for all of the Tx channel optical paths 128a. Once all the Tx channel optical paths 128a are aligned, the second fiber ferrule 56 can be secured to the isolator assembly 40. For instance, an adhesive located between the isolator assembly 40 and bottom fiber ferrule 56 may be cured, thereby permanently securing the bottom fiber assembly 52 in place.

The method can further include the step of aligning first fiber assembly 42 such that the first optical fibers 48 are aligned with respective regions on the photodetector array(s) 34. That is all active detector areas on the photodetector array(s) 34 can be aligned with optical paths originating in the first optical fibers 48 so as to maximize optical coupling efficiency between the top fiber assembly 42 and the photodetector array 34 (see FIG. 11A). The first fiber ferrule 44 may be aligned, in the lateral, transverse, and longitudinal directions and rotationally about each of these directions. Having these six degrees of adjustment freedom helps enable efficient coupling simultaneously for all of the Rx channel optical paths 128b. Once all the Rx channel optical paths 128b are aligned, the first optical fiber ferrule 44 and the second fiber ferrule 56 can be secured to each other. For instance, an adhesive located between the first fiber ferrule 44 and the second fiber ferrule 56 may be cured, permanently securing the first fiber assembly 42 in place. It should be appreciated that the first fiber assembly 42 can be secured in place before or after the second fiber assembly 52 is secured, or the first and second fiber assemblies 42 and 52 can be secured simultaneously.

The method described above enables alignment of all of the Tx channels independent of alignment of all the Rx channels. Independently aligning the Tx and Rx optical channels is advantageous, since it increases the allowable tolerances on placement of the various elements of the interconnect module subassembly. This may result in increased yields and higher coupling efficiency. In the method described above, the Tx channel optical path 128a between the Tx optical fibers an optical engine subassembly can be shorter than the Rx channel optical path 128b between the Rx optical fibers and the optical engine subassembly. An advantage of the shorter Tx channel optical path 128a is that the Tx optical channels may have tighter alignment tolerances compared with those of the Rx optical channels.

It should be appreciated that various elements that are shown as independent elements in FIGS. 1-4 may be integrated as a single unitary element. For example, rather than an independent modulator driver 30 the modulator driver 30 and optionally laser 78 may be integrated into the PIC 32. Similarly, rather than an independent transimpedance amplifier 36 the transimpedance amplifier 36 may be integrated into the PIC 32. Waveguide photodetectors may be integrated into the PIC obviating the need for a separate photodetector array 34. In this embodiment, surface grating couplers or turning mirrors may redirect the Rx optical channel paths into waveguides on the PIC 32 where the waveguide photodetectors are located. A laser may be formed by epaxial growth on an InP substrate that also serves as the substrate for the PIC 32.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

1-87. (canceled)

88. An interconnect module comprising:
a base substrate having a first surface and a second surface opposite the first surface, wherein at least a portion of the base substrate is transparent;
a photonic integrated circuit mounted on the base substrate, wherein the photonic integrated circuit originates at least one transmit channel optical path;
a photodetector array mounted on the base substrate, wherein the photodetector array terminates at least one receive channel optical path; and
an isolator assembly that includes an optical isolator and an optical block, wherein the at least one transmit channel optical path passes through the optical isolator, thereby reducing or eliminating feedback to the photonic integrated circuit, and the at least one receive channel optical path passes through the optical block.

89. The interconnect module as recited in claim 88, wherein the at least one transmit channel optical path comprises a plurality of transmit channel optical paths and the at least one receive channel optical path comprises a plurality of receive channel optical paths.

90. The interconnect module as recited in claim 89, wherein all of the plurality of transmit channel optical paths and all of the plurality of receive channel optical paths extend through the base substrate.

91. The interconnect module as recited in claim 89, wherein the photonic integrated circuit is a silicon photonics chip and each of the plurality of transmit channel optical paths originates in an optical waveguide of the silicon photonics chip.

92. The interconnect module as recited in claim 89, wherein a receive optical path length of each of the plurality of receive channel optical paths through the optical block is substantially equal to a transmit channel optical path length of each of the plurality of transmit channel optical paths through the optical isolator.

93. The interconnect module as recited in claim 92, wherein the plurality of transmit channel optical paths are offset from the plurality of receive channel optical paths in a longitudinal direction in the isolator assembly.

94. The interconnect module as recited in claim 93, wherein the plurality of transmit channel optical paths are interleaved with the plurality of receive channel optical paths in a lateral direction.

95. The interconnect module as recited in claim 89, wherein the isolator assembly is supported by the first surface of the base substrate, the interconnect module further comprising a fiber ferrule situated on a surface of the isolator assembly that faces away from the base substrate, wherein the fiber ferrule defines a first surface that faces away from the base substrate and a second surface opposite the first surface.

96. The interconnect module as recited in claim 95, wherein the fiber ferrule is transparent.

97. The interconnect module as recited in 95, wherein each of the plurality of receive channel optical paths extends through the fiber ferrule from the first surface to the second surface.

98. The interconnect module as recited in claim 95, wherein each of the plurality of transmit channel optical paths is redirected by a ferrule reflector.

99. The interconnect module as recited in claim 98, wherein none of the plurality of receive channel optical paths are redirected by the ferrule reflector.

100. The interconnect module as recited in claim 95, wherein the fiber ferrule is a bottom fiber ferrule, the interconnect module further comprising a top fiber ferrule situated on the first surface of the bottom fiber ferrule.

101. The interconnect module as recited in claim 100, wherein each of the plurality of receive channel optical paths is redirected by a top ferrule reflector.

102. The interconnect module as recited in claim 100, wherein no transmit channel optical path extends into the top fiber ferrule.

103. The interconnect module as recited in claim 89, further comprising a lens array situated between the base substrate and the isolator assembly.

104. The interconnect module as recited in claim 103, wherein all of the plurality of transmit channel optical paths and all of the plurality of receive channel optical paths extend through the lens array.

105. The interconnect module as recited in claim 88, wherein the photonic integrated circuit and the photodetector array are mounted on the second surface of the base substrate, wherein the second surface is configured to be mounted to a host substrate.

106. The interconnect module as recited in claim 88, wherein the base substrate has a plurality of inner electrical contact pads configured to be attached using a C4 solder process and a plurality of outer electrical contact pads configured to be attached using a C2 solder process and the inner electrical contact pads have a finer pitch than the outer electrical contact pads.

107. The interconnect module as recited in claim 100, wherein the top fiber ferrule supports a light delivery optical fiber.
